(19) United States
(12) Patent Application Publication
(10) Pub. No.: US 2018/0370363 A1
(43) Pub. Date: Dec. 27, 2018

(54) VEHICLE CENTER CONSOLE THAT AUTOMATICALLY ROTATES TOWARD DRIVER AND CONSOLE POSITIONING METHOD THEREOF

(71) Applicant: Pavel Vinogradov, Edmonton (CA)

(72) Inventor: Pavel Vinogradov, Edmonton (CA)

(21) Appl. No.: 16/010,606

(22) Filed: Jun. 18, 2018

Related U.S. Application Data
(60) Provisional application No. 62/523,080, filed on Jun. 21, 2017.

(51) Int. Cl. B60K 37/04; B60R 16/037

(52) U.S. Cl. CPC B60K 37/04; B60R 16/0373; B62D 25/14; B60K 2350/92; B60K 2350/901; B60K 2350/405

(57) ABSTRACT

One or more motors automatically rotate and position a center console of a vehicle for better viewability and access by a driver. When the driver pushes an activation button or speaks a voice command detected by a microphone, a driver tracking mode is entered. The driver tracking mode may also be automatically enabled upon detecting the lack of a front passenger in the vehicle. The central console moves forward and turns toward the driver's side to achieve an optimal viewing angle of approximately ninety degrees between the driver's face and the console display. The rotated position of the center console allows for easier access to buttons, icons, radio, CD/DVD player, temperature controls, etc. A console camera may be installed on the central console for facial recognition enabling the system to automatically adjust the console position to follow the driver's face for improved readability as the driver changes position over time.

### CROSS-REFERENCE TO RELATED APPLICATIONS

This application claims the benefit of priority of U.S. Provisional Application No. 62/523,080 filed Jun. 21, 2017, which is incorporated herein by reference.

### BACKGROUND OF THE INVENTION

### (1) Field of the Invention

The invention pertains generally to center consoles in vehicles such as cars and trucks. More specifically, the invention relates to a center console that automatically rotates toward a user for better accessibility.

### (2) Description of the Related Art

Modern vehicles typically include a display device providing graphical route maps and other driving information on a center console. The console is located on the dashboard between the driver seat and the front passenger seat. Other buttons and control functions may be included on the center console including air conditioning and environment control functions, radio and entertainment control dials such as volume and music selection buttons, hazard light toggle switches, clock functionality, interior light intensity controls, etc. Because the center console is conveniently located between the driver and the front passenger, both the driver and the front passenger may easily view and operate the radio, global positioning system (GPS) map planning menu, air conditioning/heating controls, and any other functionality provided thereon.

One problem with existing center consoles is that, because all items on the center consoles are intended to be accessed by both the driver and the front passenger of the vehicle, neither user has optimal visibility and access to the center console. The situation is particularly non-optimal for the driver who needs to concentrate as much as possible on driving the vehicle. Because of the center location of the center console, the driver may need to lean over and toward the center console display screen to read and access all items. The driver may have significant difficulty quickly viewing the center screen under a variety of conditions such as during bright light conditions or when text needs to be read on the center console display screen. This problem may be easily overcome by the driver simply asking the front passenger for help in reading or operating control items on the center console. However, often the driver is alone in the vehicle and there is no front passenger. In these circumstances, the driver may have their attention disrupted for an excessive duration each time they need to read or operate something on the center console. In short, the center console typically offers poor visibility and usability of controls to the vehicle driver while the vehicle is in motion.

### BRIEF SUMMARY OF THE INVENTION

In view of the aforementioned problems, an objective of certain embodiments of the invention is to improve visibility of and access to a center console panel by a specific user in a vehicle.

According to an exemplary embodiment of the invention, one or more motors automatically rotate and position a center console of a vehicle for better viewability and access by a driver. When the driver pushes an activation button or speaks a voice command detected by a microphone, a driver tracking mode is entered. The driver tracking mode may also be automatically enabled upon detecting the lack of a front passenger in the vehicle. The central console moves forward and turns toward the driver's side to achieve an optimal viewing angle of approximately ninety degrees between the driver's face and the console display. The rotated position of the center console allows for easier access to buttons, icons, radio, CD/DVD player, temperature controls, etc. A console camera may be installed on the central console for facial recognition enabling the system to automatically adjust the console position to follow the driver's face for improved readability as the driver changes position over time.

According to an exemplary embodiment of the invention there is disclosed a vehicle system including a frame, a center console mounted on the frame, and one or more motors coupled to the frame. The one or more motors are operable to dynamically adjust a position of the center console frame from a first position to a second position. The second position has an improved viewing angle between a particular user in the vehicle to a front face of the center console than the first position.

According to an exemplary embodiment of the invention there is disclosed a method of positioning a center console in a vehicle. The method includes mounting the center console on a frame, and dynamically adjusting a position of the frame from a first position to a second position. The second position has an improved viewing angle between a particular user in the vehicle to a front face of the center console than the first position.

In some embodiments, the improved viewing angle is substantially ninety degrees.

In some embodiments, the first position is a neutral position where the front face of the center console is flush with a dashboard of the vehicle, and the method includes adjusting the position of the center console frame to be at the first position in a default mode; and adjusting the position of the center console to rotate toward the particular user in a user tracking mode.

In some embodiments, the particular user is a driver of the vehicle and the user tracking mode is a driver tracking mode.

In some embodiments, the particular user is a front passenger of the vehicle and the user tracking mode is a front passenger tracking mode.

In some embodiments, the method includes automatically changing the position of the frame over time by one or more motors as a position of the particular user changes.

In some embodiments, the method includes allowing the particular user to activate the user tracking mode by pressing a button.

In some embodiments, the method includes allowing the particular user to activate the user tracking mode by speaking a voice command into a microphone.

In some embodiments, the method includes utilizing one or more sensors to allow the vehicle system to automatically activate the user tracking mode.

In some embodiments, the one or more sensors include a camera, and the method further includes detecting by the camera whether a front passenger is present in the vehicle, and in response to determining that there is no front passenger, automatically activating the user tracking mode being a driver track mode.

In some embodiments, the one or more sensors include a pressure sensor, and the method further includes detecting by the pressure sensor whether a front passenger is present in the vehicle and in response to determining that there is no front passenger, automatically activating the user tracking mode being a driver track mode.

These and other advantages and embodiments of the present invention will no doubt become apparent to those of ordinary skill in the art after reading the following detailed description of preferred embodiments illustrated in the various figures and drawings.

### BRIEF DESCRIPTION OF THE DRAWINGS

The invention will be described in greater detail with reference to the accompanying drawings which represent preferred embodiments thereof:

FIG. 1 shows a block diagram of a vehicle system according to an exemplary embodiment of the invention.

FIG. 2 illustrates a projection view of the center console while the center console frame is in a neutral position according to an exemplary embodiment.

FIG. 3 illustrates a first side view of the center console frame positioned at the neutral position within the dashboard according to an exemplary embodiment.

FIG. 4 illustrates a second side view of the center console frame while at an intermediate position after a driver track mode has been activated according to an exemplary embodiment.

FIG. 5 illustrates a third side view of the center console frame after it has turned to face the driver while in the driver track mode according to an exemplary embodiment.

FIG. 6 illustrates a first plan view of the interior of the vehicle showing the center console frame positioned at the neutral position within the dashboard according to an exemplary embodiment.

FIG. 7 illustrates a second plan view of the interior of the vehicle showing the center console frame while at an intermediate position after the driver track mode has been activated according to an exemplary embodiment.

FIG. 8 illustrates a third plan view of the interior of the vehicle showing the center console frame turned to face the driver while in the driver track mode according to an exemplary embodiment.

FIG. 9 shows a projection view of the center console while in the driver tracking mode according to an exemplary embodiment.

FIG. 10 shows a flowchart of a method of positioning the center console of a vehicle according to an exemplary embodiment.

### DETAILED DESCRIPTION

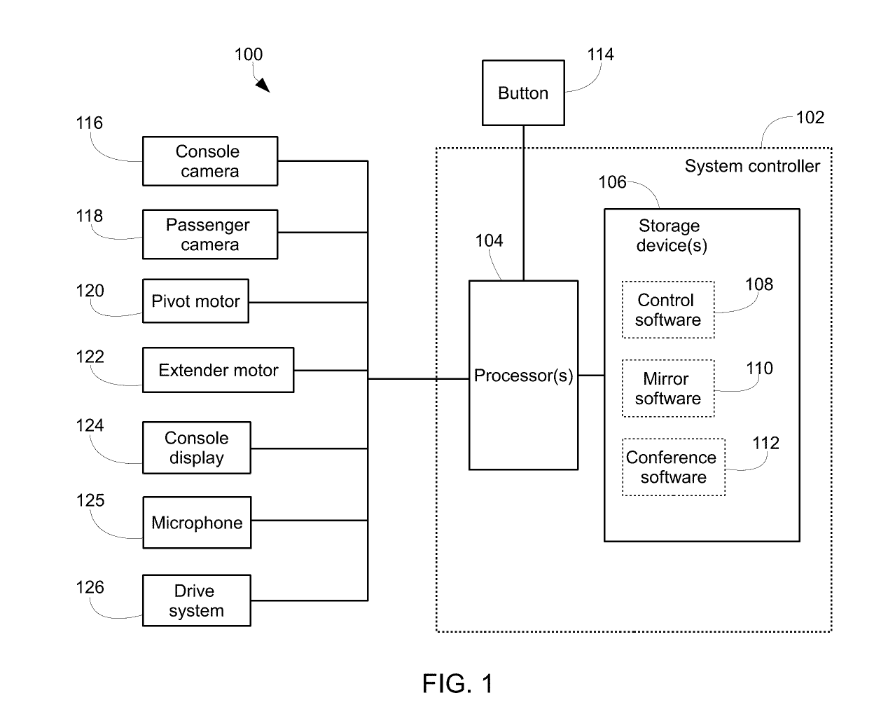

FIG. 1 shows a block diagram of a vehicle system 100 according to an exemplary embodiment of the invention. The vehicle system 100 includes a system controller 102, which itself includes one or more processor(s) 104 coupled to a storage device 106 such as a non-volatile memory device. The storage device 106 stores a plurality of software modules and data including but not limited to control software 108, camera mirror software 110, and conference software 112, for example.

The one or more processors 104 may be included in a central processor unit (CPU) of a computer server or embedded system acting as the system controller 102. In the following description, the plural form of the word “processors” will be utilized as it is common for a CPU of a computer or vehicle embedded system to have multiple processors 104 (sometimes also referred to as cores); however, it is to be understood that a single processor 104 may also be configured to perform the described functionality in other implementations.

The system 100 further includes a console camera 116 and a passenger camera 118, and both cameras 116, 118 are coupled to the processors 104. A pivot motor 120 and an extender motor 122 are also coupled to and operable by the processors 104. A center console display device 124 such as a full color liquid crystal display screen is coupled to the processors 104. A microphone 125 is coupled to the processors 104 to enable voice commands. Finally, the vehicle drive system 126 is also coupled to the processors 104 to allow the processors 104 to receive information about the current operating state of the vehicle.

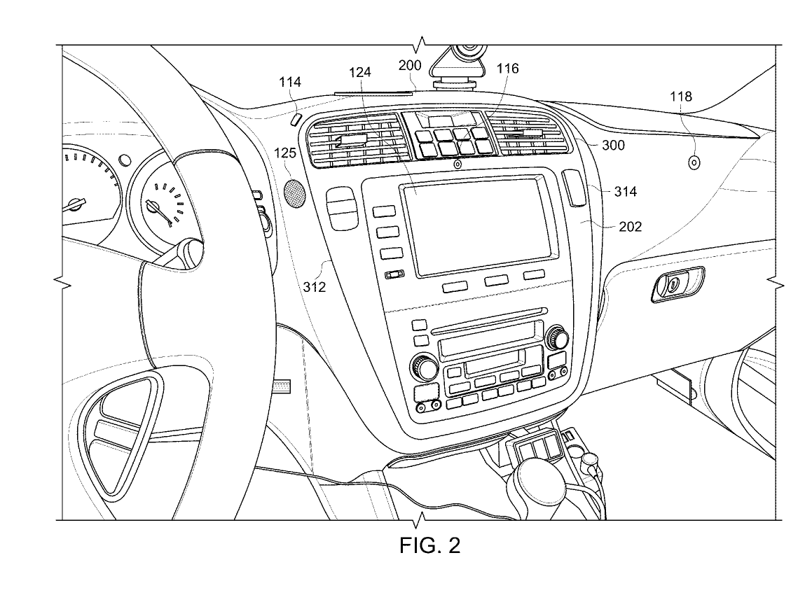

FIG. 2 illustrates a projection view of the center console 202 of the vehicle dashboard 200 while the center console frame 300 is in a neutral position according to an exemplary embodiment. As illustrated in FIG. 2, the neutral position looks like a normal center console in existing vehicles where the center console frame 300 is positioned within a cavity of the dashboard 200 such that the front face edges 312, 314 of the center console frame 300 are flush with the edges of the dashboard 200.

In this configuration, the vehicle system 100 includes a button 114 located at a position easily accessible to the driver of the vehicle. The button 114 is utilized to activate a driver tracking mode of the center console frame 300. The button 114 in the example of FIG. 2 is located on the dashboard 200; however, in other embodiments the button 114 may also be located on the steering wheel or on the front face of the center console 202 itself. The center console 202 includes the console camera 116 facing the interior of the vehicle and positioned on substantially on a vertical dividing center line of the console 202 above the display device 124. The passenger camera 118 in this embodiment is located within the dashboard substantially in front of the passenger seat.

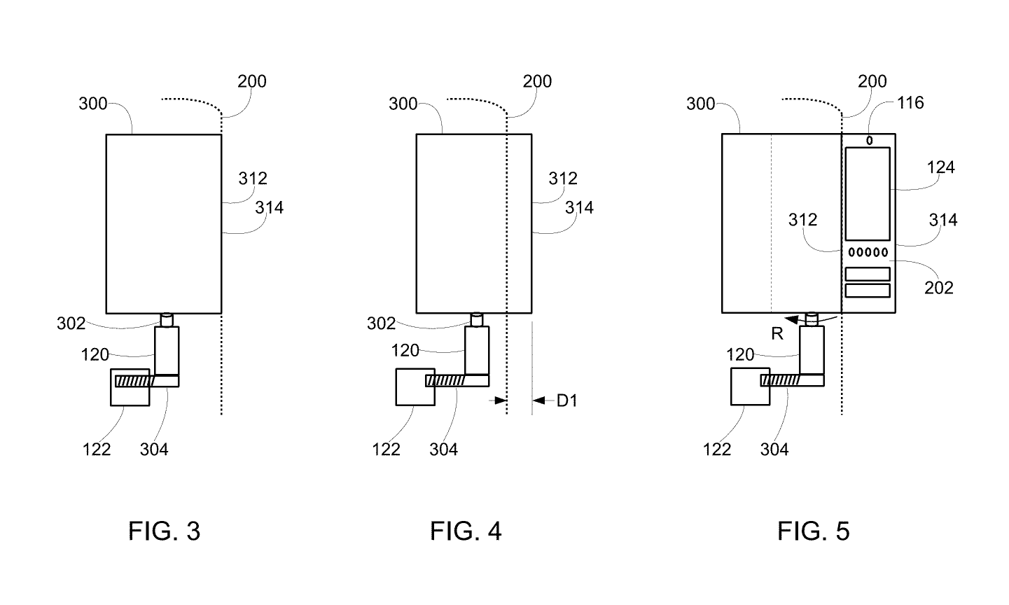

FIG. 3 illustrates a first side view of the center console frame 300 positioned at the neutral position within the dashboard 200. In FIG. 3, the front of the center console frame 300 is assumed to be toward the right side of the figure and the console frame 300 is initially positioned within a cavity in the dashboard 200 such that the front edges 312, 314 of the console 202 are flush with the dashboard 200.

As shown in FIG. 3, the pivot motor 120 is coupled to a rotation rod 302 for turning the console frame 300 toward the driver. Likewise, the extender motor 122 is coupled to a drive track 304 for moving the console frame 300 forward and backwards into and out of the dashboard cavity.

FIG. 4 illustrates a second side view of the center console frame 300 while at an intermediate position after the user has pushed the button 114 in order to activate a driver track mode. In the intermediate position, the extender motor 122 has driven the drive track 304 to move the console frame 300 forward such that the front edges 312, 314 of the frame 300 now extend a distance D1 past the front of the dashboard 200 into the interior of the vehicle.

FIG. 5 illustrates a third side view of the center console frame 300 after it has turned to face the driver while in the driver track mode. As illustrated, the pivot motor 120 has rotated the console frame 300 to turn the front face of the console 202 toward the driver for improved visibility of and access to the center console 202 by the driver. The amount of rotation R in this example is sufficient in combination with the distance D1 in order to turn the left edge 312 of the console frame 300 such that it is now flush with the dashboard 200. In this way, none of the control elements or console display 124 are hidden from view behind the dashboard 200. As a result of the rotation R, the right edge 314 now extends outward about twice the distance D1 that was illustrated in FIG. 4.

At any time, such as when driving alone, the driver is able to turn the center console 202 towards themselves at the touch of button 114 thereby improving the readability and viewing angle of the center console 202.

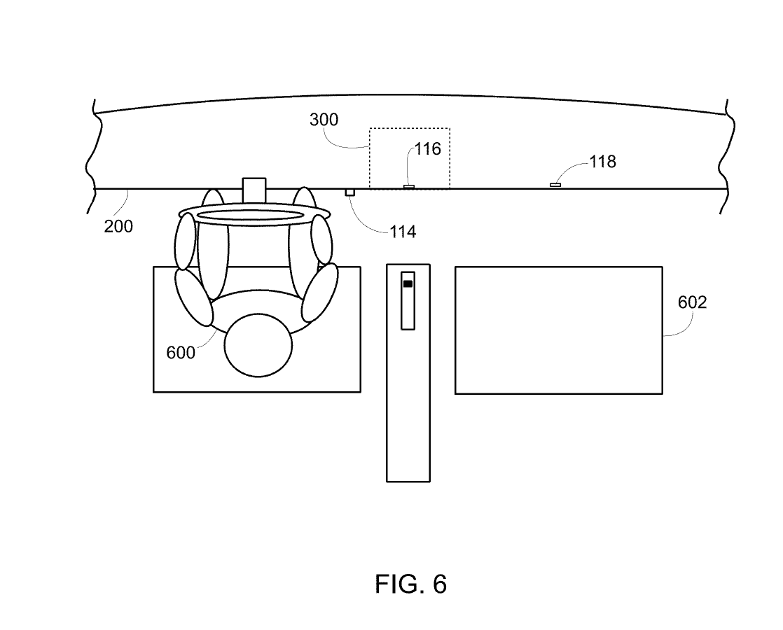

FIG. 6 illustrates a first plan view of the interior of the vehicle showing the center console frame 300 positioned at the neutral position within the dashboard 200. The dashboard 200 and front of the vehicle is located at the top of the figure and a driver 600 is positioned on the left-hand side. An empty passenger seat 602 is illustrated on the right-hand side. The position of the center console frame 300 in FIG. 6 corresponds to the neutral position shown in FIG. 3.

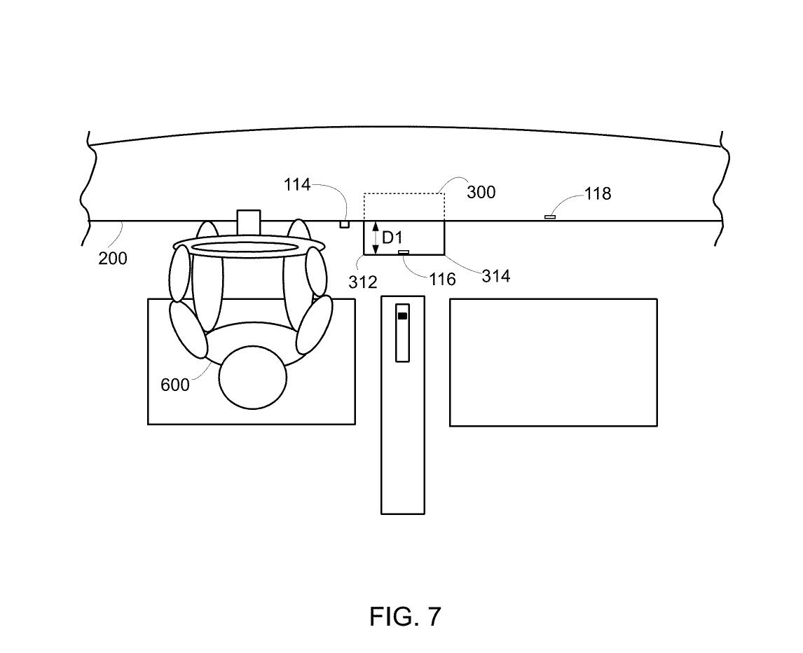

FIG. 7 illustrates a second plan view of the interior of the vehicle showing the center console frame 300 while at the intermediate position of FIG. 4 after the user has pushed the button 114 in order to activate the driver track mode. As illustrated, the front edges 312, 314 of the console frame 300 have been extended a distance D1 into the interior of the vehicle by the extender motor 122.

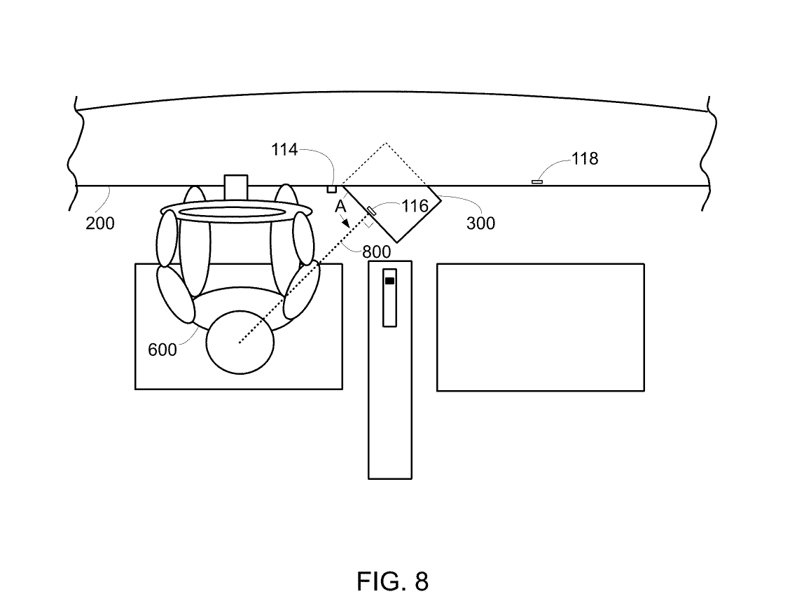

FIG. 8 illustrates a third plan view of the interior of the vehicle showing the center console frame 300 turned to face the driver 600 while in the driver track mode. The position of the center console frame 300 in FIG. 8 corresponds to that shown in FIG. 5. As illustrated, the pivot motor 120 has turned the frame 300 by an angle R such that the front face of the console 202 is perpendicular to the view line 800 of the driver 600. In other words, the viewing angle A formed between the viewing line of sight 800 from the driver 600 and the front face of the console 202 is substantially ninety degrees. In this way, the driver may briefly glance at the console 202 and easily read the display screen 124 or operate controls on the console 202 by either turning their head to the right or simply using eye movements. Because the viewing angle A is substantially perpendicular, the viewing angle A is perfectly suited to the driver 600 and results in minimum focussing effort by the user and maximum visual contrast. Likewise, buttons on the right side of the console 202 are now closer to the user and easier to reach. The rotation of the console frame 300 also reduces the requirement for the driver to lean their body toward the center of the vehicle and likewise reduces the amount of time the driver requires to view and operate the center console 202. Driver distraction viewing and operating the center console 202 is thereby reduced by providing easier access to the center console 202.

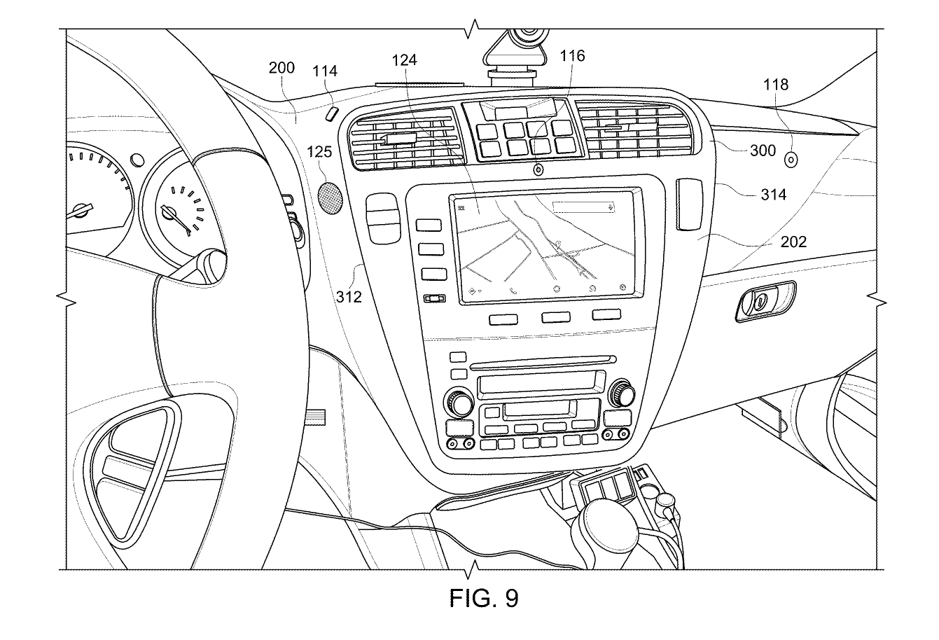

FIG. 9 shows a projection view of the center console 202 while in the driver tracking mode according to an exemplary embodiment. The view illustrated in FIG. 9 corresponds to the position of the console frame 300 illustrated in FIGS. 5 and 8. As illustrated, the console display 124 has been rotated to directly face the driver 600 and the left-side edge 312 of the console frame 300 is flush with the dashboard 200.

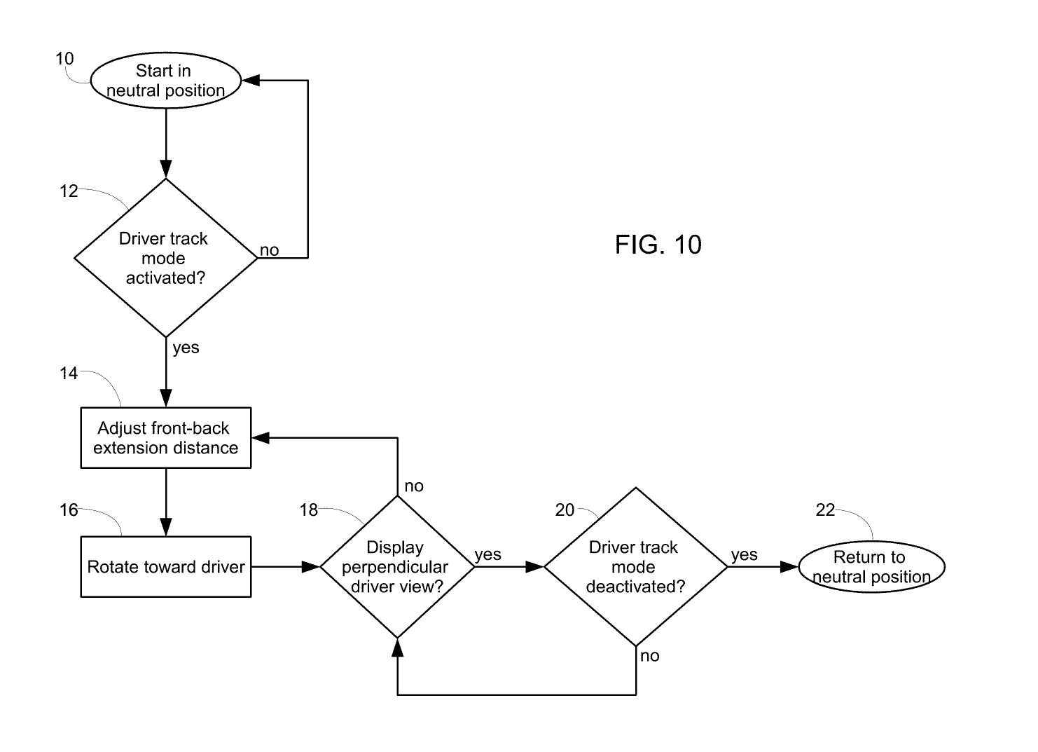

FIG. 10 shows a flowchart of a method of positioning the center console 202 of a vehicle according to an exemplary embodiment. The steps of FIG. 10 may be performed by processors 104 executing one of more of the software modules 108, 110, 112 illustrated in FIG. 1. The steps of the flowchart are not restricted to the exact order shown, and, in other configurations, shown steps may be omitted or other intermediate steps added.

The process begins at step 10 where the center console frame 300 is in the neutral position such as shown in FIGS. 2, 3, and 6. The neutral position may be the default position of the console frame 300 and the processors 104 may control the motors 120, 122 to always return the console frame 300 to the default position upon vehicle shutdown. In other embodiments, the neutral position may not be the default position; instead, the default position may be a user configurable setting and may be different for different users or vehicles. For this reason, although the flowchart of FIG. 10 is illustrated with the neutral position being the starting position, this is for description purposes only and it is not a strict requirement that the flowchart always needs to start with the center console frame 300 in the neutral position.

At step 12, the processors 104 determine whether the driver track mode should be activated. As previously illustrated, in some embodiments, the driver 600 may inform the processors 104 that the driver track mode should be activated by the user manually pushing the button 114. However, other mechanisms of activating the driver track mode may also be utilized instead of or in addition to the button 114 at step 12. For instance, voice commands may be spoken by the driver 600 for detection by the microphone 125 coupled to the processors 125. The microphone 125 may also be mounted on the dashboard 200 or may be provided by a remote system such as on a Bluetooth enabled smartphone or another device carried by the driver 600.

In yet other examples, the processors 104 may automatically activate the driver track mode at step 12 without manual input from the user. For instance, the processors 114 may monitor the presence of a front passenger according to video data received from the passenger camera 118. When there is no front passenger 118, the processors may automatically activate the driver track mode. Likewise, when there is a front passenger present in the vehicle, the processors 104 may automatically deactivate driver track mode and return the center console to the neutral position so both the passenger and the driver may view and operate the center console. Pressure sensor(s) in the passenger seat 602 may be employed in other embodiments to allow the processors 104 to monitor for the presence of a front passenger.

At step 14, because the driver track mode has been activated, the processors 104 control the extender motor 122 to adjust the lateral position of the console frame 300 by moving the console frame 300 forward into the interior of the vehicle cab. As illustrated in FIGS. 4 and 7, this step involves the extender motor 122 moving the console frame 300 forward by a distance D1. The distance D1 may initially be a predetermined number of centimetres such as 10 cm-25 cm, and the predetermined distance D1 may be a user configurable setting or a last utilized distance for a particular user as stored by the processors 104 in the storage device 102. However, as will be explained further in the following, the distance D1 need not be fixed and may instead be dynamically changed and adjusted by the processors 104 over time such as to optimize the viewing angle A for a particular driver 600 and to accommodate changes in the driver's 600 head position over time while the system 100 is in the driver track mode.

At step 16, the pivot motor 120 rotates the center console frame 300 around the rotation rod 302 in order to orient the console display 124 toward the driver 600. As shown in FIG. 5 and FIG. 8, the result of step 16 is that the face of the center console 202 is rotated by an amount R such that it forms a perpendicular viewing angle A with the view line from the user's eyes. Similar to as described for step 14, the processors 104 may dynamically adjust the rotation amount R over time in order to track the head position of the driver 600. The adjustments to the rotation R and the extender distance D1 at steps 16 and 14 may happen in conjunction and simultaneously with each other under control of the processors 104.

At step 18, the processors 104 determine whether the face of the console display 124 is perpendicular to the driver's 600 view line 800. This step may correspond with the processors 104 measuring and/or estimating the angle A illustrated in FIG. 8. The processors 104 may receive feedback from one or more sensors in order to help determine the angle A.

The console camera 116 may act as a first sensor and provide visual data that may be utilized by the processors to perform face recognition on the user in order to automatically adjust the extender motor 122 and pivot motor 124 and center the user's face on the camera 116 frame. Centering the face of the driver 600 on the image frame thereby ensures the center console frame 300 is positioned such that angle A is substantially perpendicular with the driver's view line 800. In some embodiments, the console camera 116 is fixed in positioned on the console frame 300 and is pointed outwards perpendicular from the face of the console display 124. For this reason, if the console frame 300 is rotated too far in the clockwise direction, the head/face of the driver 600 will not be centered in the image data captured by the console camera 116. In this case, the processors 104 automatically adjust the console frame 300 by controlling one or both of the extender motor 122 and the pivot motor 124 in order to center the user's head within the image data. A similar but opposite process is also applied by the processors 104 should the console frame 300 be rotated too far in the counterclockwise direction.

In some embodiments, the processors 124 control the pivot motor 124 in order to rotate the console by an appropriate R value in order to center the driver's face within the image data captured by the console camera 116. Once the driver's face is centered in the image data, the processors 104 then control the extender motor 122 in order to move the console frame 300 forward or backward such that the left forward edge 312 of the face of the console 202 is flush with the edge of the cavity of the dashboard in which the console frame 300 is located.

In FIG. 4 and FIG. 5 the extender motor 122 has driven the front edges 312, 314 forward by a distance D1 that causes the front left edge 312 to be exactly flush with the dashboard edge 200 when the console frame 300 has been rotated R degrees by the pivot motor 124. Again, over time as the driver 600 changes position (or the driver 600 changes), the processors 104 may dynamically control the pivot motor 124 to maintain the perpendicular viewing angle A and may dynamically control the extender motor 122 to ensure the front left edge 312 is flush with the edge of the dashboard 200. When the rotation R is increased in the clockwise direction, the front left edge 312 of the console frame 300 moves into the cavity of the dashboard 200 past the edge 312. If the console frame 300 were left in this position, buttons on the left side of the console 202 would be hard to access and information on the left side of the console display 124 would be impossible to read by the driver 600. For this reason, the processors 104 control the extender motor 122 to move the console frame 300 forward an appropriate amount (i.e., the processors 104 adjust the distance D1) such that the frame's left edge 312 is flush with the edge of the dashboard 200.

Any body part or aspect of the driver 600 may be automatically recognized in the image data from the console camera 116 by the processors 104 in order to dynamically position the console frame 300 in order to have a perpendicular viewing angle A. For instance, existing face recognition algorithms, eye recognition algorithms, or head recognition algorithms may be employed by the processors 104. As these algorithms are well-known in the art of image processing, further description of the specific algorithms is omitted herein for brevity.

When the viewing angle A is determined by the processors 104 to not be substantially perpendicular (i.e., not substantially 90 degrees with the driver's view line 800), control returns to steps 14 and 16 so the processors 104 can adjust the pivot and extender motors 122, 124 to better optimize the viewing angle A. On the other hand, when the viewing angle A is determined by the processors 104 to be substantially perpendicular, control proceeds to step 20.

At step 20, the processors 104 determine whether driver track mode has been deactivated. Deactivation of the driver track mode may be manually indicated by the driver 600 or another passenger in the vehicle pushing a button such as button 114. Other activation and/or deactivation button(s) may be present in the vehicle cab such as another button accessible by the front passenger for example. Driver track mode may also be automatically deactivated by the processors 104 such as when the passenger camera 118 detects the presence of a front passenger entering the vehicle. In some embodiments, the processors 104 may automatically deactivate driver track mode upon the vehicle being switched off, put in park, or put in any other predetermined mode. Information on the mode and current operating state of the vehicle may be passed from the vehicle's drive system 126 to the processors 104.

At step 22, because the driver track mode has been deactivated, the processors 104 control the extender motor 122 and pivot motor 124 to return the console frame 300 to the neutral position within the dashboard. As illustrated in FIG. 2, FIG. 3, and FIG. 6, while in the neutral position, both the driver 600 and any front passenger 800 can view the center console 300, although the viewing angle A is no longer optimal for either of these users.

In an exemplary embodiment, the processors 104 control one or more motors 122, 124 to automatically rotate and position a center console 202 for better access to a driver 600 of the vehicle. When the driver 600 pushes the activation button 114 or enables a voice command detected by microphone 125, a driver tracking mode is entered. The central console 202 starts moving forward until the console 202 is ready to be rotated. The central console 202 then turns towards the driver side to achieve an optimal viewing angle A of approximately 90 degrees between the driver's face and the console display 124. The rotated position of the console 202 allows for easier access to buttons, icons, radio, CD/DVD player, temperature controls, etc. In some embodiments, a console camera 116 is installed on the central console 202 for facial recognition so the one or more processors 104 can adjust the console 202 position to follow the driver's face for improved readability of the GPS functionality, mirroring functionality, video conference functionality, etc.

Exemplary benefits of certain embodiments include that the position of the rotated console while the system 100 is in the driver track mode is particularly helpful for people with petite builds. After pushing the activation button 114 (or in response to the processors 104 otherwise activating the driver track mode), the console panel frame 300 pops out of the dashboard 200, turns toward the driver to optimize the viewing angle A, and the distance D1 the frame 300 is extended is automatically adjusted by the processors 104 to prevent the edge 312 of the console 202 going into the hole.

In some embodiments, the center console frame 300 is mechanically designed to only allow turning toward the driver 600 in a user track mode. However, in other embodiments, the pivot motor may also turn the frame 300 toward the front passenger in another user track mode such as a passenger track mode. Passenger track mode may be similar to as described above for driver track mode except in passenger track mode the processors 104 adjust the position of the center console frame 300 to optimize for viewing by the front passenger. In passenger track mode, the console display 124 and other functionality by the center console may be unusable by the driver so the processors 104 may in some configurations prevent the system 100 from entering the passenger track mode when there is no front passenger presence detected.

Although the invention has been described in connection with preferred embodiments, it should be understood that various modifications, additions and alterations may be made to the invention by one skilled in the art without departing from the spirit and scope of the invention. For example, the above-described system 100 may also be leveraged to provide other beneficial functions in addition to providing for better console readability and accessibility by the driver 600 and/or passengers in the driver/passenger track modes. For instance, the console camera 116 on center console 202 may also act as a mirror allowing the user to see themselves on the console display 124. For instance, the driver may push the button 114 (or another button) to activate the mirror software 110 in order to see themselves on display. In this camera mirroring mode, the processors 104 reroute graphical image and video data from the console camera to the console display 124. Optionally, to increase safety, the camera mirror mode may only be activated when not driving the vehicle or in gear etc. The mode of the vehicle can be passed to the processors 124 from the drive system. The camera mirror mode may be beneficial for the driver and/or passenger to put on makeup while parked, for example.

In another example application, the camera and user tracking modes may be beneficially leveraged by video conferencing software. For instance, a Bluetooth enabled smartphone carried by the user and/or conference software 112 executed by the processors 104 may enable the driver and/or a passenger to conduct a video conference. The processors 104 may control the console frame 300 to direct the camera 116 at either the driver and/or passenger that is speaking during the conference call. In this way, a remote party can see the user during the call. Likewise, while in driver track mode, the passenger camera 118 may be leveraged to capture video of the passenger during a conference call. Thus, the console may stay visible to the driver 600 while still allowing the front passenger to attend a conference call. During conference calls, the console display 124 may display video of the remote party. Again, for safety, display of the remote party may be automatically limited by the processors 104 to only occur when the vehicle is in park and/or when the console 202 is in front passenger track mode and therefore not distracting to the driver 600.

Although the above flowchart illustrated in FIG. 10 includes a feedback decision at step 18 in order to determine whether the viewing angle A is optimal, this feedback loop may be omitted in other embodiments. For instance, during a setup phase, a particular user sitting in the driver seat may configure the system 100 to set a preferred console position for that user. The processors 104 may save this configuration data for the user in the storage device. Thereafter, when the user presses the button 114 or otherwise activates the driver track mode, the processors 104 control the extender and pivot motors 122, 124 to move the console frame 300 to the user's preferred location. Different users may have different preferred positions stored in the storage device 106 and the processors 104 may automatically identify users based on known user identification techniques such as by the unique car keys utilized by different users.

In yet another modification example, other degrees of freedom besides front back extension and rotation can be utilized. For instance, although the above examples include an extender motor 122 and pivot motor 124, in other embodiments different motors and degrees of freedom may be employed. For example, to accommodate drivers 600 of different heights, an elevation motor that tilts the console frame 300 up and down may also be employed. Furthermore, any types of motors and actuators may be employed to allow the processors 104 to move the console frame 300. The above hardware with drive track 304 and rotation rod 302 were employed for their simplicity of implementation; however, any known mechanical actuator to move a frame in any desired degrees of motion may be employed in other embodiments in a similar manner.

The above exemplary software modules 108, 110, 112 may be implemented by software executed by one or more processors 104 operating pursuant to instructions stored on a tangible computer-readable medium such as a storage device to perform the above-described functions of any or all aspects of the access controller. Examples of the tangible computer-readable medium include optical media (e.g., CD-ROM, DVD discs), magnetic media (e.g., hard drives, diskettes), and other electronically readable media such as flash storage devices and memory devices (e.g., RAM, ROM). The computer-readable medium may be local to the computer executing the instructions, or may be remote to this computer such as when coupled to the computer via a computer network such as the Internet. The processors may be included in a general-purpose or specific-purpose computer that becomes the system controller 102 or any of the above-described modules as a result of executing the instructions.

In other embodiments, rather than being software modules executed by one or more processors 104, the modules 108, 110, 112 and the functionality described above as being performed by the processors 104 may be implemented as hardware modules configured to perform the above-described functions of the processors 104. Examples of hardware modules include combinations of logic gates, integrated circuits, field programmable gate arrays, and application specific integrated circuits, and other analog and digital circuit designs.

Functions of single modules may be separated into multiple units, or the functions of multiple modules may be combined into a single unit. Unless otherwise specified, features described may be implemented in hardware or software according to different design requirements. In addition to a dedicated physical computing device, the word “server” may also mean a service daemon on a single computer, virtual computer, or shared physical computer or computers, for example. All combinations and permutations of the above described features and embodiments may be utilized in conjunction with the invention.

What is claimed is:

1. A vehicle system comprising:
a frame;
a center console mounted on the frame; and
one or more motors coupled to the frame;
wherein the one or more motors dynamically adjust a position of the frame from a first position to a second position; and
the second position has an improved viewing angle between a particular user in the vehicle to a front face of the center console than the first position.

2. The vehicle system of claim 1, wherein the improved viewing angle is substantially ninety degrees.

3. The vehicle system of claim 1, wherein the one or more motors comprise:
a pivot motor for rotating the frame; and
an extender motor for moving the frame forward into an interior of the vehicle and backward into a cavity within a dashboard of the vehicle.

4. The vehicle system of claim 1, further comprising:
one or more processors; and
a storage device memory coupled to the one or more processors;
wherein the storage device stores instructions that are executed by the one or more processors thereby causing the one or more processors to operate the one or more motors in order to dynamically adjust the position of the center console frame.

5. The vehicle system of claim 4, further comprising:
a console camera mounted on the frame and coupled to the one or more processors;
wherein the one or more processors receive a plurality of image data from the console camera, perform an object recognition algorithm in order to detect a position of a target object in the image data, and operate the one or more motors in order to move the frame such that the target object is centered in the image data.

6. The vehicle system of claim 1, wherein:
the first position is a neutral position where the front face of the center console is flush with a dashboard of the vehicle;
in a default mode, the one or more motors adjust the position of the center console frame to be at the first position; and
in a user tracking mode, the one or more motors adjust the position of the center console to rotate toward the particular user.

7. The vehicle system of claim 6, wherein the particular user is a driver of the vehicle and the user tracking mode is a driver tracking mode.

8. The vehicle system of claim 6, wherein the particular user is a front passenger of the vehicle and the user tracking mode is a front passenger tracking mode.

9. The vehicle system of claim 6, wherein the one or more motors automatically change the position of the frame over time as a position of the particular user changes.

10. The vehicle system of claim 6, further comprising a button allowing the particular user to activate the user tracking mode.

11. The vehicle system of claim 6, further comprising a microphone allowing the particular user to activate the user tracking mode.

12. The vehicle system of claim 6, further comprising one or more sensors allowing the vehicle system to automatically activate the user tracking mode.

13. The vehicle system of claim 12, wherein:
the one or more sensors include a camera that detects whether a front passenger is present in the vehicle; and
in response to determining that there is no front passenger, the vehicle system automatically activates the user tracking mode being a driver track mode.

14. The vehicle system of claim 12, wherein:
the one or more sensors include a pressure sensor that detects whether a front passenger is present in the vehicle; and
in response to determining that there is no front passenger, the vehicle system automatically activates the user tracking mode being a driver track mode.

15. The vehicle system of claim 1, further comprising:
a plurality of microphones;
the front face of the center console in the first position is directed toward a first user;
the front face of the center console in the second position is directed toward a second user; and
the one or more motors are controlled to selectively adjust the position of the frame between the first position and the second position according to audio signals received from the plurality of microphones.

16. A method of positioning a center console in a vehicle, the method comprising:
mounting the center console on a frame; and
dynamically adjusting a position of the frame from a first position to a second position;
wherein the second position has an improved viewing angle between a particular user in the vehicle to a front face of the center console than the first position.

17. The method of claim 16, further comprising
providing a pivot motor for rotating the frame; and
providing an extender motor for moving the frame forward into an interior of the vehicle and backward into a cavity within a dashboard of the vehicle.

18. The method of claim 16, further comprising:
providing one or more processors; and
providing a storage device memory coupled to the one or more processors;
wherein the storage device stores instructions that are executed by the one or more processors thereby causing the one or more processors to operate one or more motors in order to dynamically adjust the position of the center console frame.

19. The method of claim 18, further comprising:
providing a console camera mounted on the frame and coupled to the one or more processors; and
receiving a plurality of image data from the console camera by the one or more processors;
performing an object recognition algorithm by the one or more processors in order to detect a position of a target object in the image data; and
operating the one or more motors by the one or more processors in order to move the frame such that the target object is centered in the image data.

20. A non-transitory processor-readable medium comprising processor executable a plurality of instructions that when executed by one or more processors cause the one or more processors to perform steps of:
dynamically adjusting a center console in a vehicle from a first position to a second position;
wherein the second position has an improved viewing angle between a particular user in the vehicle to a front face of the center console than the first position.
